(19) United States
(12) Patent Application Publication
(10) Pub. No.: US 2003/0026092 A1
(43) Pub. Date: Feb. 6, 2003

(54) Rechargeable light having capacitor-based power source

(75) Inventors: Dian H. Reese, Holland, MI (US); Jason M. Denbow, South Haven, MI (US); Brant J. Potter, Holland, MI (US); Scott R. Meyers, Holland, MI (US); Scott A. Hansen, Holland, MI (US)

Correspondence Address: Steven C. Becker, FOLEY & LARDNER, Firstar Center, 777 East Wisconsin Avenue, Milwaukee, WI, 53202-5367, US

(73) Assignee: Johnson Controls Technology Company

(21) Appl. No.: 09/918,941

(22) Filed: Jul. 31, 2001

(51) Int. Cl. B60Q 3/00; F21L 4/08

(52) U.S. Cl. 362/183; 362/496; 362/488; 362/276; 320/167

(57) ABSTRACT

A rechargeable light includes a body, a light source coupled to the body, a capacitor, and a power interface switch. The capacitor is configured to provide power to the light source. The capacitor and light source are configured to provide sustained light. The power interface is configured to be coupled to a power source external to the body and to provide power to charge the capacitor.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present specification relates to rechargeable lights. More specifically, the present specification relates to a rechargeable light having a capacitor-based power source.

### BACKGROUND OF THE INVENTION

Rechargeable lights (e.g., flashlights) are used for various outdoor, traveling, home, and other applications. In particular, consumers have a need for a vehicle-mountable rechargeable light.

Existing rechargeable lights utilize rechargeable batteries, such as, nickel cadmium, and other rechargeable battery technologies. However, existing rechargeable batteries have numerous disadvantages. Rechargeable battery performance is susceptible to temperature changes, a problem that is particularly disadvantageous in an automobile environment, where temperatures can range from below freezing temperatures to over 60° Celsius. For example, in temperatures under 20° Celsius, the ability to take a charge is degraded in nickel cadmium batteries. Further, rechargeable batteries have slow charge rates on the order of many hours, and also discharge when not in use. Further still, rechargeable batteries suffer from memory effect, potential environmental hazards, and other issues that make using rechargeable batteries not preferred, particularly in an automobile environment.

Current efforts at improving rechargeable flashlights and other rechargeable devices are focused on improving the life, charge capacity, and other performance features of rechargeable batteries. Such improvements have found applications in laptop computers, wireless phones, personal digital assistants, and other portable electronic devices.

There is a need for a simpler solution for portable light sources, such as flashlights. Further, there is a need for a rechargeable light operable without the use of rechargeable batteries. Further still, there is a need for a rechargeable light that can be powered without the use of rechargeable batteries, which is chargeable from a power source external to the light. Further yet, there is a need for a rechargeable light having an improved power supply, the light being mountable to the interior of a vehicle and powered from the vehicle power source.

Further still, there is a need for a rechargeable flashlight having an increased number of “recharging cycles” in the lifetime of the flashlight. Further still, there is a need for a rechargeable flashlight that can retain a full charge over a longer period of time than prior rechargeable flashlights. Further still, there is a need for a rechargeable flashlight having a shorter recharging time then prior rechargeable flashlights. Further still, there is a need for a rechargeable flashlight operable over a wider temperature range without performance degradation than prior rechargeable flashlights. Further still, there is a need for a rechargeable flashlight useful for emergency applications. Further still, there is a need for a rechargeable flashlight that has a lighter weight than prior rechargeable flashlights.

The teachings hereinbelow extend to those embodiments which fall within the scope of the appended claims, regardless of whether they accomplish one or more of the above-mentioned needs.

### SUMMARY OF THE INVENTION

According to one exemplary embodiment, a rechargeable light includes a body, a light source coupled to the body, a capacitor, and a power interface. The capacitor is configured to provide power to the light source. The capacitor and light source are configured to provide sustained light. The power interface is configured to be coupled to a power source external to the body and to provide power to charge the capacitor.

According to another exemplary embodiment, a rechargeable light includes a body, a light source coupled to the body, a capacitor, and a power interface. The capacitor is configured to provide power to the light source. The power interface is configured to be coupled to a power source external to the body and to provide power to charge the capacitor. The rechargeable flashlight does not include a battery.

According to yet another exemplary embodiment, a portable light source includes a means for providing light, a capacitor means for storing power and for providing power to the means for providing light, and a means for receiving power from a source external to the portable light source and for charging the capacitor means.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a schematic diagram of a rechargeable light, according to an exemplary embodiment;

FIG. 2 is a top view of a headliner for an automobile having a rechargeable light attachable thereto, according to an exemplary embodiment;

FIG. 3 is a front view of a vehicle door having a rechargeable light attachable thereto, according to an exemplary embodiment;

FIG. 4 is a partial cross-sectional view of a power interface for a rechargeable light and a second power interface coupled to a vehicle interior element, according to an exemplary embodiment;

FIG. 5 is a partial cross-sectional view of a wall-mountable interface circuit and a household power source, according to an exemplary embodiment;

FIG. 6 is a perspective view of a rechargeable light in a first position, according to an exemplary embodiment;

FIG. 7 is a perspective view of a rechargeable light in a second position, according to an exemplary embodiment; and

FIG. 8 is a partial cut-away, cross-sectional view of a rechargeable light having a magnet-coil system, according to an exemplary embodiment.

### DETAILED DESCRIPTION OF EXEMPLARY EMBODIMENTS

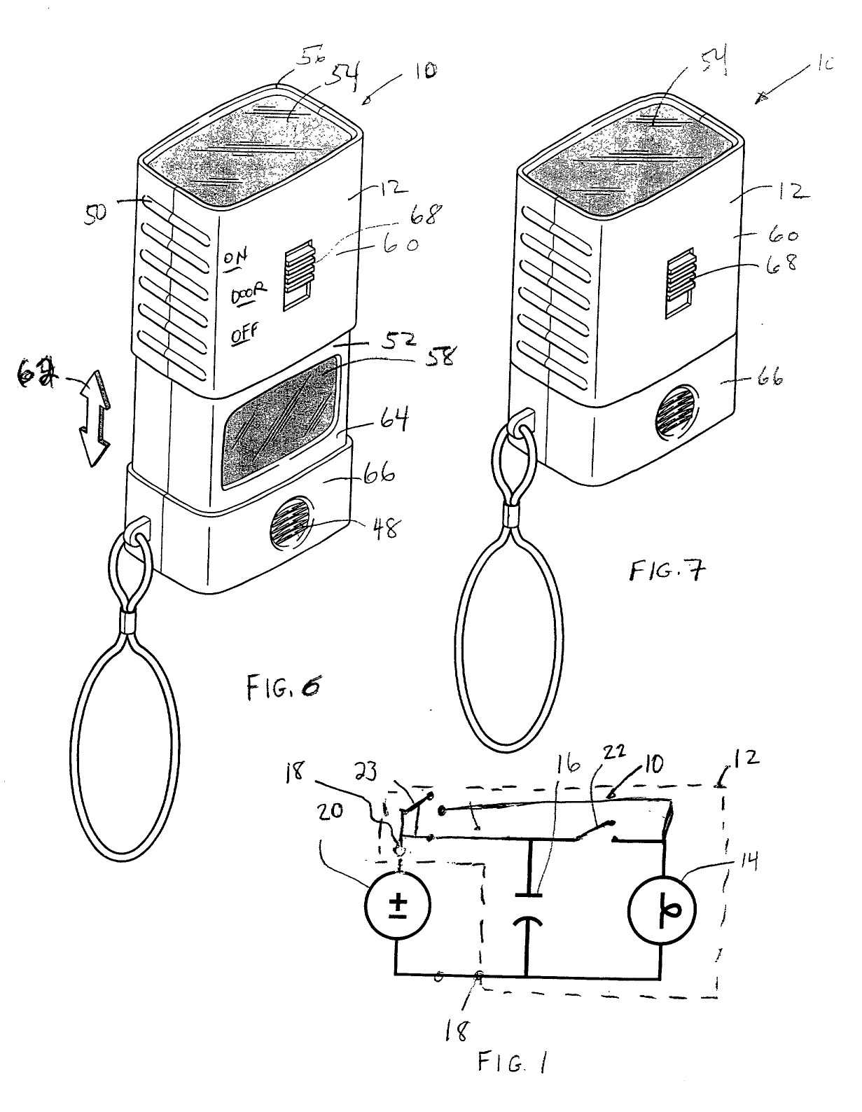

Referring first to FIG. 1, a schematic diagram of a portable light source 10 is illustrated. Portable light source 10 is preferably of sufficient size and weight to be carried by a person in a portable manner. Advantageously, portable light source 10 is a rechargeable light (e.g., a flashlight) in this exemplary embodiment.

Rechargeable light 10 includes a body 12 which encases a light source 14 and a capacitor 16. Alternatively, light source 14 and/or capacitor 16 may be partially or wholly disposed outside body 12. Body 12 may comprise any of a variety of plastics, polymers, rubbers, or other materials. Additional characteristics of body 12 will be disclosed with reference to FIGS. 2-8 hereinbelow. Light source 14 includes one or more light-emitting diodes (LEDs) in this exemplary embodiment, but may alternatively include a fluorescent or incandescent light bulb or other light-emitting source. LED 14 may be an amber or white diode and can be packaged in groups of 2, 4, 8, etc. to increase the brightness or adjust between multiple intensity levels. An LED is preferable to a light bulb in this embodiment because an LED draws much less current than a light bulb. For example, a typical LED having a voltage of 2.5 Volts (V) draws 20 milliAmperes (mA) of current. A suitable low-current light bulb has a voltage of 12 V which draws 500 mA. In an embodiment wherein a light bulb is used, the light bulb will be a low-current light bulb, drawing approximately 900 mA or less. Use of low-ampere light sources provides a longer flashlight life for one full charge of capacitor 16. Further, multiple LEDs, light bulbs, and LEDs of different colors and intensities may be used.

According to one advantageous aspect of this exemplary embodiment, capacitor 16 is configured to provide power to light source 14. Accordingly, capacitor 16 is a large capacitor, having a Farad (F) rating of at least 10 F. Alternative embodiments may use super capacitors or ultra capacitors having Farad ratings of at least 10 F, at least 50 F, or more. Such capacitors typically have the physical size of a rechargeable battery, but provide advantageous features over a conventional rechargeable battery. In various alternative embodiments, the size and construction of capacitor 16 can be selected based on the characteristics of light source 14 to provide a suitably sustained light source. A sustained light source includes any duration of light suitable for a standard flashlight use, and excluding transient light sources on the order of less than 1 second. For example, a sustained light source preferably provides light for at least several seconds and preferably many minutes or even hours. As capacitor technology and light source technology improve, a capacitor-based light source can provide a sustained light source of many hours. An exemplary capacitor suitable for use herein is a PC10 ultra capacitor, manufactured by Powercache, San Diego, Calif. Another exemplary capacitor suitable for use in this exemplary embodiment is a Power Stor Aerogel Capacitor B Series having a capacitance value between 1 F and 50 F, manufactured by Cooper Electronic Technologies, Boynton Beach, Fla. In alternative embodiments, several capacitors may be provided in series to provide additional voltage for certain light sources.

Rechargeable light 10 further includes a power interface 18 configured to be coupled to a power source external to body 12 and to provide power to capacitor 16. In this exemplary embodiment, power interface 18 includes electrical contacts coupled to body 12 which provide an electrical interface between an external power source 20 and light source 14 and capacitor 16. Power interface 18 may include only two electrical contacts, or may include additional circuit elements to provide signal conditioning, such as, AC to DC power conversion, voltage splitting, current limiting, high frequency or high power filtering, etc. External power source 20 may be any type of external power source, such as, a battery, a power circuit, a power generator, a wall-mounted power outlet, an automobile power supply, such as a vehicle battery, or other power sources. Light source 14 may be powered directly from power source 20 or may be powered from capacitor 16. Light source 14 may be powered while capacitor 16 is being charged from power source 20, or light source 14 may be disabled during charging of capacitor 16.

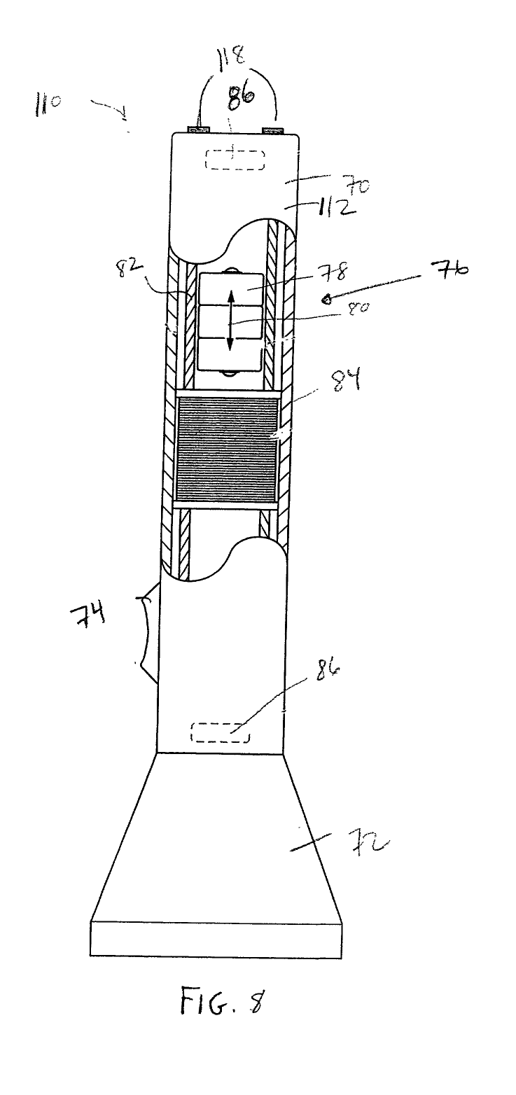

Rechargeable light 10 may further include a switch 22, such as a simple contact switch, an operator-actuatable switch, etc., to enable and disable providing power from capacitor 16 to light source 14. Additional exemplary embodiments of switch 22 are described hereinbelow with reference to FIGS. 6 and 7.

Rechargeable light 10 may further be configured to include a switch 23 to enable the operation of a courtesy light. A courtesy light is a light operable in response to the opening or closing of a door on a vehicle or in response to a button press or a remote keyless entry (RKE) device. As shown in FIG. 1, switch 23 is shown in a courtesy light OFF position. When switched to a courtesy light ON position, power is provided from external power source 20 to light source 14 in response to a door on a vehicle opening (wherein the door may be a passenger door, lift-gate, glove box, etc.), and wherein external power source 20 provides no power to light source 14 when the vehicle door is closed. Thus, switches 22 and 23 may be combined into a single three-position switch, having an OFF position, a DOOR position (in which the courtesy light function is active) and an ON position. (See, for example, FIG. 6).

In operation, capacitor 16 provides power to light source 14 in a portable light source suitable for use by a person in a variety of lighting situations. The user may actuate switch 22 to enable and disable light source 14. Further, capacitor 16 may be powered from an external power source 20 to provide the advantage of recharging capacitor 16 in an easy and efficient manner. Capacitor 16 will have a greater number of charge cycles and a slower discharge time when not in use than a standard NiCad rechargeable battery, is operable in a greater range of temperatures than a NiCad battery, and has a longer life span (both in number of recharge cycles and in years of use) than a typical NiCad battery. Further, capacitor 16 charges quickly, for example, on the order of minutes or an hour, while NiCads can take as long as 17 hours or longer to charge. Further, when used in an automobile, rechargeable light 10 may go unused for extended periods, during which time a rechargeable battery may no longer be functional. Advantageously, capacitor 16 will be charged and ready for operation even after many years.

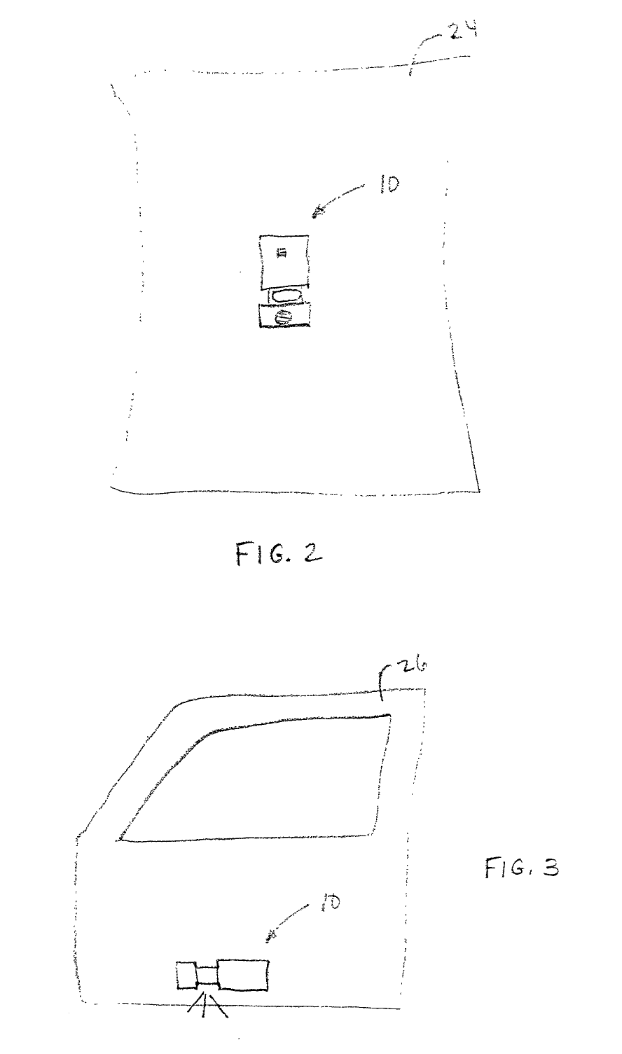

Referring now to FIG. 2 and FIG. 3, a further advantageous aspect of rechargeable light 10 is illustrated. In this exemplary embodiment, flashlight 10 is configured to be coupled to a vehicle interior element, such as, a headliner 24, a door 26 (e.g., a side door, a lift-gate, etc.), a glove box, an instrument panel, a vehicle seat, the floor, the trunk, under a seat, or any other mounting location within the interior of a vehicle. The vehicle interior element may be a cargo space (i.e., any space rearward of the front seats suitable for holding cargo). A suitable coupling device is provided on either or both of the vehicle interior element 24, 26 and rechargeable light 10, which may include an electrical and/or mechanical coupling device. According to one exemplary embodiment, a detent mechanism may be provided that allows an operator to slide a connecting element on rechargeable light 10 into a mating connecting element on the vehicle interior element 24, 26, wherein the detent mechanism locks rechargeable light 10 into place. According to a further advantageous embodiment, such a coupling device may further include an electrical coupling arrangement wherein rechargeable light 10 receives power at power interface 18 from a second power interface within the vehicle interior element 24, 26. Further still, a separate courtesy light power line may be provided in addition to vehicle power and ground.

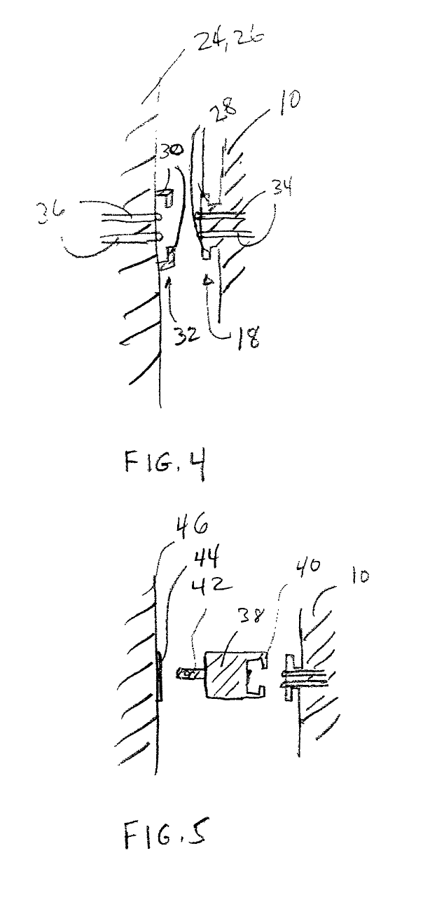

Referring now to FIG. 4, an exemplary coupling device for coupling rechargeable light 10 and vehicle interior element 24, 26 is illustrated in a cross-sectional view. Power interface 18 includes connecting elements 28 suitable for mating alignment with connecting elements 30 in a second power interface integral with or coupled to vehicle interior element 24, 26. When rechargeable light 10 is secured to vehicle interior element 24, 26 via interfaces 18, 32, electrical contacts 34 and 36 are configured to pass electrical power from vehicle interior element 24, 26 to rechargeable light 10, and more specifically, to capacitor 16. Electrical contacts 36 may further be coupled to any vehicle power source, such as, the vehicle ignition power source, the vehicle battery, the vehicle alternator, or another vehicle-based power source. As a further alternative, interface 18 may be configured for coupling to a cigarette lighter or other courtesy power port to draw power therefrom. Accordingly, in this advantageous embodiment, rechargeable light 10 recharges capacitor 16 in a quick and efficient manner while coupled to vehicle interior element 24, 26. In an embodiment wherein light 10 is used as a courtesy light, a third electrical contact 36 (not shown) may be provided at interface 32 with a corresponding third electrical contact 34 at interface 18. The third electrical contact carries power in response to the open or closed state of a vehicle door.

Referring now to FIG. 5, rechargeable light 10 may also be charged in a wall-mounted household power outlet. Advantageously, a wall-mountable interface circuit 38 having a flashlight interface portion 40 and a wall-mounted power outlet interface portion 42 is provided. Wall-mountable interface 38 includes an AC-to-DC power converter to convert standard wall power to a DC power suitable for rechargeable light 10. Rechargeable light 10 is charged from a common household power outlet 44 in the wall 46 of a house, office, or other building. Wall-mountable interface circuit 38 may be integrally molded with portable light source 10 or separable therefrom. In this exemplary embodiment, rechargeable light 10 may be used for multiple functions including an automotive interior light, a household night light, and a flashlight. Further, rechargeable light 10 may include one or more light sources for each of these functions, examples of which will be provided hereinbelow with reference to FIG. 6 and FIG. 7. A further function of rechargeable light 10 could be for use as an emergency flashing light which utilizes one or several light sources, which may be red, orange, or yellow and may provide a higher intensity light than the flashlight or night light functions.

Referring now to FIG. 6 and FIG. 7, these figures illustrate a perspective view of rechargeable light 10 according to an exemplary embodiment. Body 12 includes several features which assist a user in gripping and operating rechargeable light 10. As illustrated in FIG. 6, body 12 includes a grip 48 including a recess and several parallel ribs within the recess, the recess having a size approximately that of a finger. Grip 48 is configured to allow the user to grip a bottom portion 66 of body 12. A second, larger grip 50 includes a plurality of horizontal bumps protruding outward from an outer surface of body 12 having a total area approximately that of several fingers of a user to allow the user to grab an upper portion 60 of body 12.

In this exemplary embodiment, rechargeable light 10 includes a plurality of light sources, one aimed in an upward direction and one aimed out of side 52 of rechargeable light 10. Alternatively, a single light source may be used to provide light through a first lens 54 at a top 56 of rechargeable light 10 and a second lens 58 on side 52. In this embodiment, lens 54 directs light from the light source (not shown) in a conical or a torch-shaped fashion typical of a standard flashlight. Lens 58 scatters light from the light source to provide scattered light to an area, such as the interior of a vehicle, in a manner similar to a dome light of a vehicle. Numerous other configurations of lenses and light sources are contemplated.

As illustrated in the views of FIG. 6 and FIG. 7, FIG. 6 illustrates rechargeable light 10 in a first position, wherein lens 58 is exposed, and wherein a top portion 60 of body 12 is slid upward (as indicated by arrow 62) in a telescoping fashion over a middle portion 64 of body 12 to an interference fit. A user may effectuate this movement to the first position by gripping a bottom portion 66 of body 12, preferably using grip 48, and then sliding top portion 60 upward, preferably using grip 50. Portion 60 includes a locking mechanism (e.g., an interference fit) suitable for locking portion 60 into place in the first position. As illustrated in FIG. 7, the user may again slide top portion 60 back toward bottom portion 66 to place rechargeable light 10 in the second position.

According to one embodiment, rechargeable light 10 may be in the first position wherein light is provided only through lens 58 while rechargeable light 10 is mounted to vehicle interior element 24, 26, and rechargeable light 10 is placed in the second position, in which light is provided only through lens 54 when the user removes the rechargeable flashlight from the vehicle interior element in order to use rechargeable flashlight as a portable light source. Switch 68 is operable in ON, OFF, or DOOR positions, as discussed hereinabove with reference to switches 22 and 23 in FIG. 1.

Referring now to FIG. 8, yet another exemplary embodiment of the rechargeable flashlight is illustrated. In this embodiment, a more conventional flashlight-shaped body 112 is shown having a long, cylindrical base portion 70 and a conically-shaped light portion 72. A switch 74 is provided for enabling and disabling rechargeable light 10. Also illustrated in a partial cut-away cross-sectional view is a magnet-coil charging system 76 including a magnet 78 slidable as indicated by arrow 80 within an inner sleeve 82. Magnet 78 and inner sleeve 82 have corresponding shapes, which are circular in cross section, but may alternatively be cylindrical, triangular, rectangular, or other shapes. System 76 further includes a coil 84 of wire wrapped around inner sleeve 82 with a plurality of turns. Magnet-coil charging system 76 may further include repel magnets 86, which are optional, or another repel device, such as a spring, located at the distal ends of inner sleeve 82. In alternative arrangements, magnet-coil charging system 76 may include fewer than the elements listed.

Rechargeable flashlight 110 further includes a power interface 118 which comprises two electrical contacts similar to those disclosed in the embodiment of FIG. 1. Advantageously, rechargeable flashlight 110 in the embodiment of FIG. 8 may be charged by either magnet-coil charging system 76 and/or power interface 118 which receives power from an external power source.

In operation, the user shakes body 112 in the directions of arrow 80 which causes magnet 78 to move within inner sleeve 82 past coil 84. This movement induces a charge in coil 84 which is coupled to capacitor 116 (not shown). In this manner, capacitor 116 may be charged by simply shaking rechargeable flashlight 110. Alternatively, capacitor 116 may be charged by power interface 118 from a power source external to body 110. In this manner, rechargeable flashlight can be mounted to a vehicle interior element, to a household wall power outlet, or to another power source external to body 112 for charging, and may further be charged away from such an external power source by shaking body 112. Repel magnets 86 prevent magnet 78 from hitting the distal ends of inner sleeve 82 with great force. Advantageously, should a user remove rechargeable flashlight 110 from the vehicle and deplete all power stored in capacitor 116 (e.g., several minutes or several hours), the user can recharge the flashlight at a remote location by shaking body 112.

While the exemplary embodiments illustrated in the FIGS. and described above are presently preferred, it should be understood that these embodiments are offered by way of example only. For example, various body configurations and vehicle interior mounting configurations may be used other than those disclosed herein. Furthermore, one of ordinary skill in the art, based on the teachings herein, will understand that various permutations of capacitor types and sizes and light source types and sizes may be combined to provide rechargeable flashlights having different sizes, weights, sustained light durations, and other desirable characteristics. Accordingly, the present invention is not limited to a particular embodiment, but extends to various modifications that nevertheless fall within the scope of the appended claims.

What is claimed is:

1. A rechargeable flashlight, comprising:
a body;
a light source coupled to the body;
a capacitor configured to provide power to the light source, wherein the capacitor and light source are configured to provide sustained light; and
a power interface configured to be coupled to a power source external to the body and to provide power to charge the capacitor.

2. The rechargeable flashlight of claim 1, wherein the capacitor is at least 10 Farads.

3. The rechargeable flashlight of claim 2, wherein the capacitor is at least 50 Farads.

4. The rechargeable flashlight of claim 1, wherein the light source includes a light-emitting diode.

5. The rechargeable flashlight of claim 1, wherein the body is configured to be coupled to a vehicle interior element.

6. The rechargeable flashlight of claim 5, wherein the power interface is configured to receive vehicle power through the vehicle interior element.

7. The rechargeable flashlight of claim 6, further comprising a magnet-coil system responsive to motion to charge the capacitor.

8. The rechargeable flashlight of claim 5, wherein the vehicle interior element is a cargo space.

9. The rechargeable flashlight of claim 1, further comprising an operator-actuatable switch coupled to the body configured to enable the light source in a first position and to disable the light source in a second position.

10. The rechargeable flashlight of claim 1, wherein the switch has a third position in which the flashlight enables or disables the light source in response to a courtesy light signal received from a vehicle power system via the power interface.

11. The rechargeable flashlight of claim 1, further comprising a wall-mountable interface configured to provide power from a household power source to the capacitor through the power interface.

12. The rechargeable flashlight of claim 1, further comprising a second light source and means for enabling one of the light source and the second light source.

13. The rechargeable flashlight of claim 1, wherein the power interface is further configured to provide power directly from the power source to the light source.

14. The rechargeable flashlight of claim 1, further comprising a magnet-coil system responsive to motion to charge the capacitor.

15. The rechargeable flashlight of claim 1, wherein the power interface is configured to draw power from a courtesy power port of a vehicle.

16. A rechargeable flashlight, comprising:
a body;
a light source coupled to the body;
a capacitor configured to provide power to the light source; and
a power interface configured to be coupled to a power source external to the body and to provide power to charge the capacitor, wherein the rechargeable flashlight does not include a battery.

17. The rechargeable flashlight of claim 16, wherein the capacitor and light source are configured to provide sustained light.

18. The rechargeable flashlight of claim 16, wherein the capacitor is greater than 10 Farads.

19. The rechargeable flashlight of claim 16, wherein the light source includes a light-emitting diode.

20. The rechargeable flashlight of claim 16, wherein the body is configured to be coupled to a vehicle interior element, wherein the power interface is configured to receive vehicle power through the vehicle interior element.

21. The rechargeable flashlight of claim 16, further comprising a magnet-coil system responsive to motion to charge the capacitor.

22. The rechargeable flashlight of claim 16, further comprising:
a vehicle interior element configured for mounting to a vehicle interior; and
a vehicle interface circuit coupled to the vehicle interior element and configured to receive vehicle power, wherein the power interface is configured to be coupled to the vehicle interface circuit.

23. A portable light source, comprising:
means for providing light;
capacitor means for storing power and for providing power to the means for providing light; and
means for receiving power from a source external to the portable light source and for charging the capacitor means.

24. The portable light source of claim 23, further comprising means for mounting the portable light source to a vehicle interior.

25. The portable light source of claim 23, further comprising magnet-coil means for charging the capacitor means.
